(19) United States
(12) Patent Application Publication
(10) Pub. No.: US 2003/0189661 A1
(43) Pub. Date: Oct. 9, 2003

(54) Systems and methods for using a digital imaging device using a near-eye viewfinder adapter

(76) Inventors: Matt Flach, Fort Collins, CO (US); Heather N. Bean, Fort Collins, CO (US); Mark N. Robins, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/117,018

(22) Filed: Apr. 4, 2002

(51) Int. Cl. H04N 5/222

(52) U.S. Cl. 348/333.09

(57) ABSTRACT

In one embodiment, the present invention is directed to an imaging device. The imaging device comprises a near-eye viewfinder that is operable to display an image using image data associated with the imaging device; and a viewing structure that is adapted to be placed over the near-eye viewfinder, wherein the viewing structure comprises a screen member that is operable to partially scatter light associated with the displayed image thereby permitting the image to be viewed from a greater field of view than the near-eye viewfinder provides.

### TECHNICAL FIELD

The present invention is related to displaying an image to a user and more particularly to displaying an image to multiple users from a digital imaging device utilizing a display adapter structure.

### BACKGROUND OF THE INVENTION

FIG. 1 depicts digital imaging device 100 (e.g., a digital camera or a digital camcorder) capturing an image of object 101 according to the prior art. Light is reflected from object 101 and is received by optical subsystem 102. Optical subsystem 102 optically reduces the image of object 101 to focus the image on Charge-Coupled Device (CCD) 103. CCD 103 is typically implemented as a two-dimensional array of photosensitive capacitive elements. When light is incident on the photosensitive elements of CCD 103, charge is trapped in a depletion region of the semiconductor material of the elements. The amount of charge associated with the photosensitive capacitive elements is related to the intensity of light incident on the respective elements received over a sampling period. Accordingly, the image is captured by determining the intensity of incident light at the respective photosensitive capacitive elements via sampling the elements.

The analog information produced by the photosensitive capacitive elements is converted to digital information by analog-to-digital (A/D) conversion unit 104. A/D conversion unit 104 may convert the analog information received from CCD 103 in either a serial or parallel manner. The converted digital information may be stored in memory 105 (e.g., random access memory). The digital information is then processed by CPU 106 according to control software stored in ROM 107 (e.g., Programmable Read Only Memory (PROM), Erasable Programmable Read Only Memory (EPROM), Electronically Erasable Programmable Read Only Memory (EEPROM), and/or the like). For example, the digital information may be compressed according to the Joint Photographic Experts Group (JPEG) standard. Additionally or alternatively, other circuitry (not shown) may be utilized to process the captured image such as an application specific integrated circuit (ASIC). User interface 108 (e.g., buttons, toggles, keys, and/or the like) may be utilized to edit the captured and processed image. The image may then be provided to output port 109. For example, the user may cause the image to be downloaded to a personal computer (not shown) via output port 109.

Additionally, digital imaging device 100 may present digital images to a user. Digital information defining a respective digital image or images may be stored in memory 105. Under the control of CPU 106, the digital information may be provided to video driver 110. Video driver 110 may drive display 111 to present a respective image to a user. The user may utilize user interface 108 to scroll through a number of images, to edit images, to delete images, to transfer selected images to another system via output port 109, and/or the like.

Display 111 may be implemented as a “near-eye viewfinder.” FIG. 2A depicts digital camera 200 that includes near-eye viewfinder display 201 and FIG. 2B provides an enlarged depiction of near-eye viewfinder display 201. Near-eye viewfinder display 201 is typically implemented utilizing an array of light emitting diodes (LEDs), although a small liquid crystal display (LCD) may also be utilized. Near-eye viewfinder display 201 may be associated with a plastic frame or the like to shield the display from ambient light. A user typically views a captured image by locating near-eye viewfinder 201 proximate to the user's eye. Because near-eye viewfinder is utilized in this manner, the size of the array of LEDs is reduced. Accordingly, the cost of the array is reduced and the power consumption of the array is minimized.

However, this arrangement is problematic. Specifically, the design of the near-eye viewfinder display 201 necessarily limits its use to one user at a time. However, digital cameras and other digital image devices (e.g., camcorders) are frequently utilized at social events where several individuals may wish to view the captured images. In these situations, the digital imaging device must be passed from individual to individual.

### BRIEF SUMMARY OF THE INVENTION

In one embodiment, the present invention is directed to an imaging device. The imaging device comprises a near-eye viewfinder that is operable to display an image using image data associated with the imaging device; and a viewing structure that is adapted to be placed over the near-eye viewfinder, wherein the viewing structure comprises a screen member that is operable to partially scatter light associated with the displayed image thereby permitting the image to be viewed from a greater field of view than the near-eye viewfinder provides.

### BRIEF DESCRIPTION OF THE DRAWINGS

FIG. 1 depicts a block diagram of a digital imaging device according to the prior art.

FIG. 2A depicts a digital camera including a near-eye viewfinder according to the prior art.

FIG. 2B depicts an enlarged portion of the digital camera shown in FIG. 2A.

FIG. 3A depicts a “side” view of a near-eye viewfinder adapter according to embodiments of the present invention.

FIG. 3B depicts a “rear” view of a near-eye viewfinder adapter according to embodiments of the present invention.

FIG. 4 depicts a digital camera with a near-eye viewfinder adapter according to embodiments of the present invention.

FIG. 5 depicts a near-eye viewfinder that is adapted to operate with the near-eye viewfinder adapter depicted in FIGS. 3A and 3B according to embodiments of the present invention.

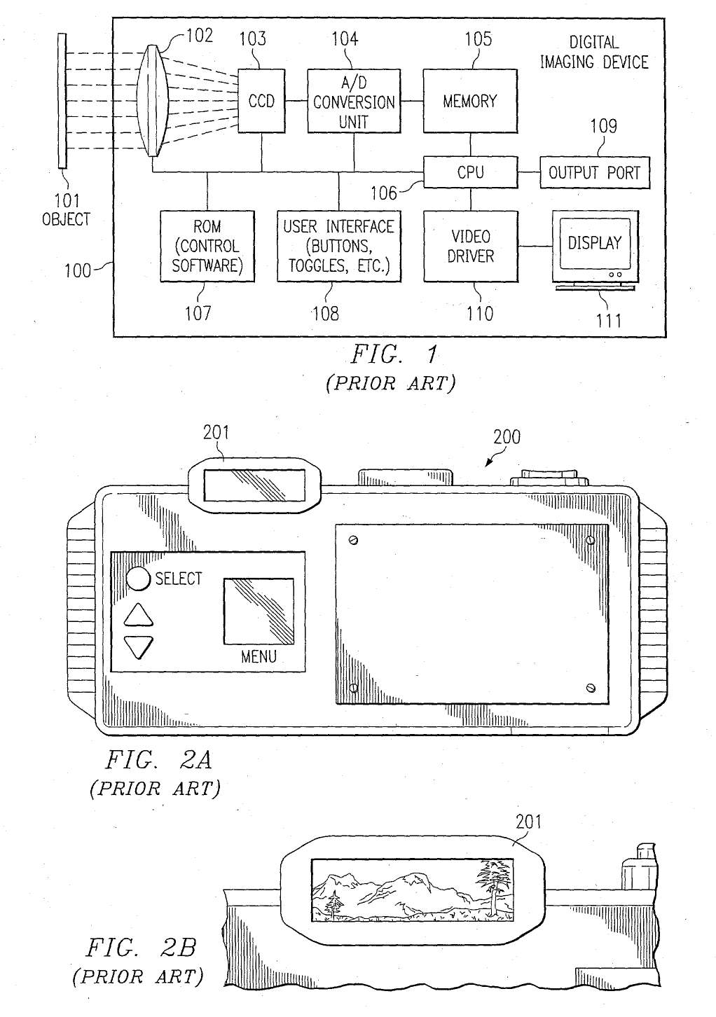

### DETAILED DESCRIPTION OF THE INVENTION

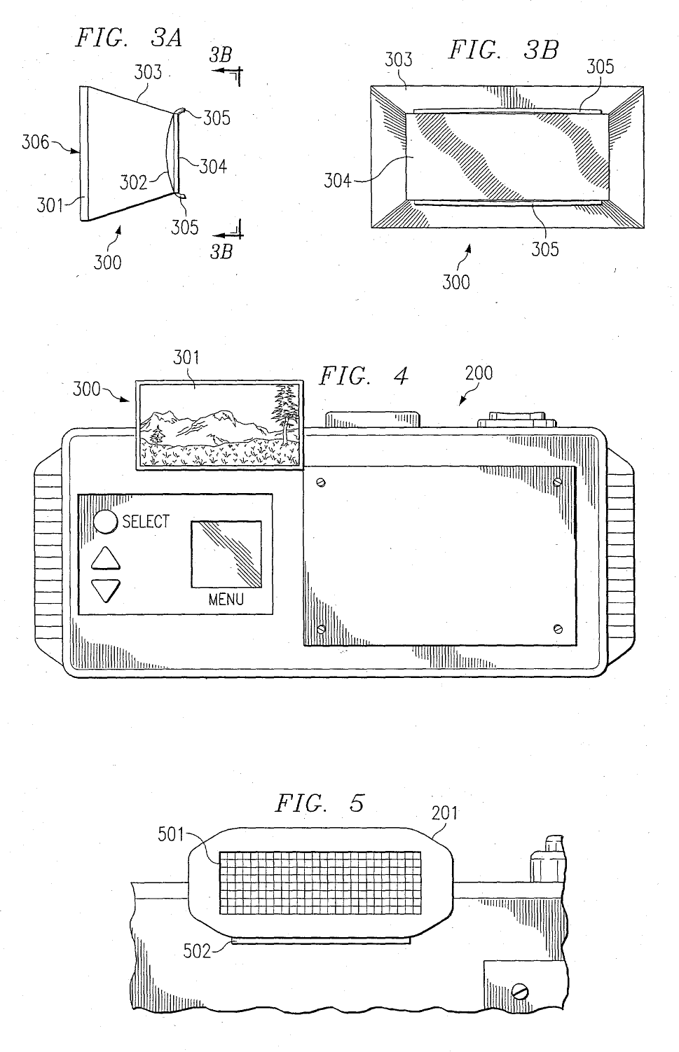

FIG. 3A depicts a “side” view of near-eye viewfinder adapter 300 according to embodiments of the present invention. Near-eye viewfinder adapter 300 may comprise aperture 304 which is approximately sized according to a selected near-eye viewfinder. Near-eye viewfinder adapter 300 may be mounted such that aperture 304 is disposed adjacent to the selected near-eye viewfinder of a digital imaging device.

Near-eye viewfinder adapter 300 may further comprise screen 301. Screen 301 may be implemented utilizing translucent plastic, glass, or other suitable material. The material selected for screen 301 preferably possesses an opacity that is similar to frosted glass. Specifically, the selected material preferably transmits a significant proportion of incident optical energy. However, the selected material preferably scatters or diffuses incident optical energy to a degree. The amount of scattering or diffusion preferably is sufficient to permit the image to be viewed from a wider field of view than permitted solely by the near-eye viewfinder. However, the amount of scattering or diffusion is preferably balanced to avoid overly reducing the quality of the image view via screen 301. Various techniques may be utilized to achieve the desired optical qualities. For example, etching techniques may be utilized if glass is selected as the material for screen 301. Alternatively, various thermoplastic polymers or the like may be utilized in the selected plastic material. In other embodiments, dielectric or other suitable thin-film coatings 306 may be provided to screen 301 to provide the desired optical properties. Moreover, dielectric or other suitable thin-film coatings 306 may additionally provide scratch resistance and/or an anti-reflective quality.

Screen 301 is preferably larger than aperture 304 to provide a larger viewing area than the viewing area defined the near-eye viewfinder. Accordingly, near-eye viewfinder adapter 300 may further comprise optic 302 that is adapted to magnify or optically enlarge light emitted from light emitting diodes (LEDs) of a digital imaging device's near-eye viewfinder. Optic 302 may also focus the emitted light onto screen 301. Additionally, optic 302 may be adapted to correct or address any optical distortion associated with the emitted light.

Near-eye viewfinder adapter 300 may further comprise opaque frame 303. Frame 303 preferably shields screen 301 from ambient light to increase the image quality associated with an image projected on screen 301. Frame 303 may be constructed utilizing any suitable material. Preferably, the selected material of frame 303 may possess sufficient structural rigidly to maintain screen 301 in a fixed position relative to optic 302 and aperture 304. Suitable materials include metallic materials and suitable thermoplastic resins.

Near-eye viewfinder adapter 300 may further comprise attaching members 305. Attaching members 305 are preferably adapted to snap over or attach to the periphery of the selected near-eye viewfinder of a digital imaging device. Attaching members 305 are preferably deformable subject to a spring force to permit attaching members 305 to be selectively affixed to the near-eye viewfinder as desired by a user. Attaching members 305 may extend over peripheral edges of near-eye viewfinder adapter 300 or may be disposed at selected portions (e.g., the corners).

FIG. 3B depicts a “rear” view of near-eye viewfinder adapter 300 according to embodiments of the present invention. Near-eye viewfinder adapter 300 is shown with aperture 304. Frame 303 is shown as extending (into the page) from aperture 304 toward the front portion of near-eye viewfinder adapter 300. As depicted in FIG. 3B, near-eye viewfinder adapter 300 is implemented as possessing attaching members 305 above and below aperture 304.

FIG. 4 depicts near-eye viewfinder adapter 300 attached to digital camera 200. Because screen 301 is preferably implemented to possess the desired optical properties and is a larger size than the viewing area of near-eye viewfinder 201, the image projected onto screen 301 is simultaneously viewable by a number of individuals. Moreover, the projected image is viewable from different angles. Accordingly, with near-eye viewfinder adapter 300, digital camera 200 need not be passed from individual to individual to view its captured digital images.

It shall be appreciated that some amount of image degradation does occur when the light emitted from the LED array is projected onto screen 301. However, the amount of degradation is not significant in light of the common uses of the instant viewing functionality of digital imaging devices. Consumers typically utilize the instant viewing functionality to determine whether digital images satisfy some minimum characteristics (e.g., every person of a group photograph is visible in the image). Users typically prefer to view the final digital images on another device (e.g., a television or personal computer screen). Accordingly, the image quality associated with screen 301 is more than sufficient to permit users to determine whether additional images should be captured to obtain their desired results.

In embodiments of the present invention, near-eye viewfinder adapter 300 may be used with preexisting digital imaging devices. In other embodiments, a digital imaging device may be adapted for use with near-eye viewfinder adapter 300. FIG. 5 depicts near-eye viewfinder 201 that is adapted according to embodiments of the present invention. Near-eye viewfinder 201 may comprise LED array 501. In preferred embodiments of the present invention, near-eye viewfinder 201 may operate in two different modes. In a first mode, near-eye viewfinder 201 operates at a first power level when it is being viewed by a single user. In a second mode, near-eye viewfinder 201 operates at a second higher power level when it is being used in conjunction with near-eye viewfinder adapter 300. The second mode may be initiated autonomously by providing sensor 502 to detect when said adapter is placed over near-eye viewfinder 201 or may be initiated in response to user input. The higher power level increases the intensity of the emitted light to increase the image quality associated with screen 301. The higher power level may be implemented by driving the existing LEDs at a higher level. Additionally, the higher power level may be facilitated by utilizing a greater density of LEDs in LED array 501 than is typically utilized.

By implementing near-eye viewfinder adapter 300 according to embodiments of the present invention, several advantages are presented. For example, digital camera 200 need not possess a relatively large liquid crystal display (LCD) to permit multiple individuals to simultaneously view digital images. Accordingly, embodiments of the present invention may effect an increase in functionality without incurring as a significant cost as employing a relatively large LCD screen. Moreover, embodiments of the present invention utilize appreciably less power than digital imaging devices that employ such LCD screens.

1. An imaging device, comprising:
a near-eye viewfinder that is operable to display an image using image data associated with said imaging device; and
a viewing structure that is adapted to be placed over said near-eye viewfinder, wherein said viewing structure comprises a screen member that is operable to partially scatter light associated with said displayed image thereby permitting said image to be viewed from a greater field of view than said near-eye viewfinder provides.

2. The imaging device of claim 1 wherein said viewing structure possesses an aperture that possesses a size that approximately corresponds to a viewable area of said near-eye viewfinder.

3. The imaging device of claim 2 wherein said screen member is larger than said aperture, said viewing structure further comprising:
an optic that is operable to optically enlarge said image for projection on said screen member.

4. The imaging device of claim 1 wherein said screen member is constructed of material selected from the list of: glass and plastic.

5. The imaging device of claim 1 wherein said screen member comprises a coating that is operable to scatter light associated with said displayed image.

6. The imaging device of claim 1 wherein said viewing structure comprises:
at least one attaching member for coupling said viewing structure to said near-eye viewfinder.

7. The imaging device of claim 6 wherein said at least one attaching member is operable to exert a force against said near-eye viewfinder to hold said viewing structure in place when said viewing structure is placed over said near-eye viewfinder.

8. The imaging device of claim 1 wherein said viewing structure comprises a substantially opaque frame that shields said screen member from ambient light.

9. The imaging device of claim 1 wherein said imaging device is operable in a first mode of operation that displays said image at a first power and is operable in a second mode of operation that displays said image at a second power that is higher than said first power.

10. The imaging device of claim 9 wherein said digital imaging device is operable to switch from said first mode of operation to said second mode of operation in response to placement of said viewing structure over said near-eye viewfinder.

11. A method of operating an imaging device, comprising:
displaying an image on a near-eye viewfinder; and
attaching a viewing structure to said near-eye viewfinder, wherein said viewing structure comprises a screen member that is operable to partially scatter light associated with said displayed image to permit said image to be viewed from a greater field of view than said near-eye viewfinder provides.

12. The method of claim 11 wherein said viewing structure comprises an aperture that is approximately equal in size to a viewing area of said near-eye viewfinder.

13. The method of claim 12 wherein said screen member is larger that said aperture, said method further comprising:
optically enlarging said image for projection on said screen member.

14. The method of claim 11 wherein said screen member comprises material selected from the list consisting of: glass and plastic.

15. The method of claim 11 wherein said screen member comprises a coating that is operable to scatter light associated with said displayed image.

16. The method of claim 11 further comprising:
detecting when said viewing structure is attached to said near-eye viewfinder by a sensor of said imaging device.

17. The method of claim 11 further comprising:
increasing display power associated with said displayed image.

18. The method of claim 17 wherein said increasing display power occurs autonomously in response to sensing said viewing structure is attached to said near-eye viewfinder.

19. The method of claim 17 wherein said increasing display power occurs in response to a user input.

20. The method of claim 11 further comprising:
shielding said screen member from ambient light with an opaque frame of said viewing structure.

21. A viewing structure that is operable to permit a near-eye viewfinder to be utilized simultaneously by a plurality of users of a digital imaging device, said viewing structure comprising:
an aperture adapted to said near-eye viewfinder;
a screen member that is operable to partially scatter light associated with an image displayed by said near-eye viewfinder permitting said image to be viewed from a greater field of view than said near-eye viewfinder provides; and
a frame member that is operable to shield ambient light from said screen member.

22. The viewing structure of claim 21 wherein said screen member is larger than said aperture, said viewing structure further comprising:
an optic that is operable to optically enlarge said displayed image for projection on said screen member.

23. The viewing structure of claim 21 wherein said screen member is constructed of material selected from the list of: glass and plastic.

24. The viewing structure of claim 21 further comprising:
at least one attaching member for coupling said viewing structure to said near-eye viewfinder.
